(19) United States
(12) Patent Application Publication
(10) Pub. No.: US 2015/0293355 A1
(43) Pub. Date: Oct. 15, 2015

(54) HEAD-UP DISPLAY DEVICE AND METHOD

(71) Applicant: RENAULT s.a.s., Boulogne-Billancourt (FR)

(72) Inventors: Mamy Pouliquen, Vanves (FR); Vincent Carreau, Paris (FR); Xavier Lesachey, Les Clayes Sous Bois (FR); Jean-Jacques Loeillet, Toulouse (FR)

(73) Assignee: RENAULT s.a.s., Boulogne-Billancourt (FR)

(21) Appl. No.: 14/434,590

(22) PCT Filed: Oct. 17, 2013
(86) PCT No.: PCT/FR2013/052480

§ 371 Date: Jun. 18, 2015

(30) Foreign Application Priority Data
Oct. 10, 2012 (FR) 1259637
Oct. 17, 2012 (FR) 1259884

(51) Int. Cl. G02B 27/01; H04N 9/31

(52) U.S. Cl. CPC G02B 27/01; G02B 27/0101; H04N 9/31; G02B 2027/015; G02B 2027/0127

(57) ABSTRACT

A head-up display device and method, for displaying at least one image, including: at least one projection mechanism generating a light beam laden with an image to be displayed; a partially reflecting screen including at least one near display zone and one far display zone configured to display the image in a field of vision of a user; and an active element configured to receive the light beam from the projection mechanism and transmit the light beam alternately to the display zones.

### TECHNICAL FIELD OF THE INVENTION

The present invention relates to the field of head-up display devices, more commonly referred to by the acronym HUD.

Such devices are generally implemented in cockpits of airplanes, trains or even ships, but also in motor vehicles (cars, trucks, etc.).

### STATE OF THE ART

The current locomotive means are increasingly being equipped with electronic driving assistance systems for the greater safety and greater comfort of the driver.

Such systems relate, for example, to frontal display devices of the head-up display or HUD type. This type of device, by improving the accessibility for the driver to information relating to the vehicle, thus offers safer driving by reducing the switching of the gaze between the driving and the displayed information.

It is known that such information can be displayed by different types of display.

In effect, in the prior art, these displays can relate for example to a screen of LCD (liquid crystal display) technology positioned above the steering wheel:

However, such placement inside the vehicle poses problems linked to architectural, ergonomic and regulatory constraints.

These displays can also relate to those head-up devices described in the documents WO2010139889 or even FR2914070. In effect, these devices are configured to convey information via a partially reflecting plate of glass or even on a part and/or a specific area of a windshield, of a vehicle, specially treated to ensure a rendering of information optically projected from a light box.

However, such devices have the major drawbacks of being very bulky notably because they consist of a particular light box which requires a significant volume under the dashboard.

Furthermore, with the democratization of the driving aids and alerts associated with the embedded systems, the current displays and, more particularly, the dashboard, are becoming limited: lack of space, reduction of the size of the elements displayed, problem of legibility of the information, problem of discrimination of the elements, etc.

The present invention aims to resolve these problems resulting from the drawbacks of the prior art.

### DISCLOSURE OF THE INVENTION

The invention aims to resolve the problem linked to reducing the bulk of head-up display devices, while improving the legibility of the information that they are likely to display.

To this end, one aspect of the invention relates to a head-up display device, for displaying at least one image, comprising:
a projection means for generating a light beam charged with an image to be displayed;
a partially reflecting screen comprising at least one near display area and one far display area arranged to display said image in the field of vision of a user, and
an active element arranged to receive the light beam from the projection means and transmit it alternately to the display areas.

According to particular embodiments:
the active element is linked to a light beam characteristics management module which is capable of synchronizing the variation of the light transmission properties of said active element as a function of said characteristics;
the active element relates to an active light diffuser such as a PDLC film;
the near display area relates to an area of the partially reflecting screen comprising luminescent particles suitable for emitting a radiation of a wavelength in the visible range after absorption of the light beam;
the projection means is a laser pico projector;
the active element is of the transmissive type and is arranged between the projection means and the display areas, and
the active element is of the reflective type and is arranged between a mirror and the projection means, said mirror being suitable for reflecting the light beam originating from the active element on the optical path toward the display areas.

The invention relates also to a head-up display method, for displaying at least one image, comprising the following steps:
generation by a projection means of a light beam charged with an image to be displayed;
display in the field of vision of a user of said image in at least one near display area and one far display area arranged in a partially reflecting screen, and
a step of alternate transmission by an active element of the light beam emitted by the projection means to the display areas.

Advantageously, the method comprises a step of synchronization of the variation of the light transmission properties of said active element as a function of the characteristics of the light beam from a management module for said characteristics linked to said active element.

### DESCRIPTION OF THE FIGURES

Other advantages and features of the invention will become more apparent on reading the following description of a preferred embodiment, with reference to the figures below, given by way of indicative and nonlimiting example:

FIG. 1 represents a laminated windshield according to one embodiment of the invention;

FIG. 2 describes the principle of excitation of the luminescent particles of the display area of a windshield according to one embodiment of the invention;

FIG. 3 represents an optical diagram of the creation of a virtual image in the partially reflecting area of the windshield according to one embodiment of the invention;

FIG. 4A represents an active element of the transmissive type, in light diffusion state according to one embodiment of the invention;

FIG. 4B represents an active element of the transmissive type, in transparency state according to one embodiment of the invention;

FIG. 5A represents an active element of the reflective type, in light diffusion state according to one embodiment of the invention;

FIG. 5B represents an active element of the reflective type, in transparency state according to one embodiment of the invention;

FIG. 6 represents an optical diagram illustrating the construction of two parallel images from a single projection means according to one embodiment of the invention;

FIG. 7 represents a diagram relating to the creation of an interleaved image from a flow of information according to one embodiment of the invention;

FIG. 8A describes the principle of image interleaving according to one embodiment of the invention;

FIG. 8B represents a diagram illustrating the addressing of the images in interleaved image mode according to one embodiment of the invention;

FIG. 9 describes the principle of interleaving of images of different dimensions according to one embodiment of the invention;

FIG. 10 represents a diagram illustrating the addressing of the images in alternate image mode according to one embodiment of the invention;

FIG. 11 illustrates a projection means with an active element according to one embodiment of the invention;

FIG. 12 represents an optical diagram illustrating a projection of a virtual image and a reflection of an exciting source from a single projection means according to one embodiment of the invention, and

FIG. 13 represents the position of the display areas according to one embodiment of the invention.

### EMBODIMENTS OF THE INVENTION

The head-up display device, for displaying at least one image, comprises:
at least one projection means 4 for generating a light beam charged with an image to be displayed;
a partially transparent and partially reflecting screen 7 comprising at least one near display area and one far display area arranged to display said image in the field of vision of a user, and
an optical system defining an optical path between the projector and one of the display areas to direct the light beam onto the display area.
a non-planar mirror which makes it possible to increase the distance of the optical path.
a light diffusion element on which is created the initial image which is transmitted all along the optical path. Depending on the technology employed, this diffusion element may be situated in the projector 4.

The projection means 4 relates, nonexhaustively, to: any projection means 4 used generally in the conventional head-up display devices. For example, a device based on active liquid crystals backlit in transmission mode, a device based on active liquid crystals backlit in reflection mode or a pico projector incorporating a matrix of micro-mirrors reflecting a light source, or even a laser pico projector.

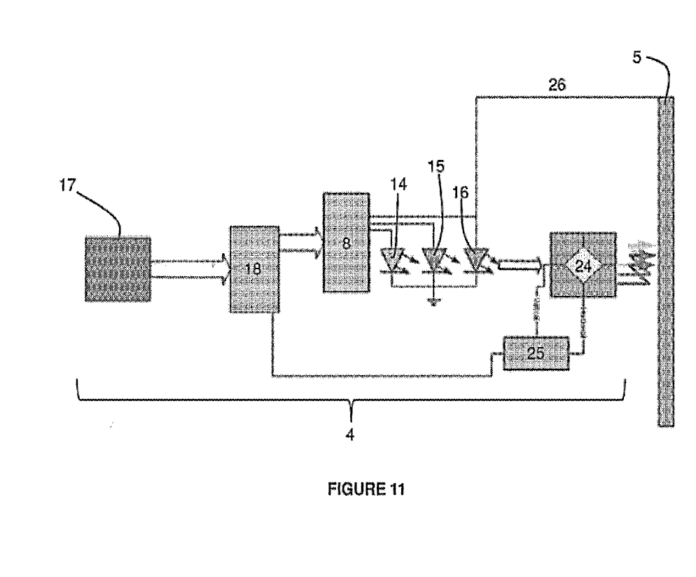

FIG. 11 represents a laser pico projector which corresponds to a video projector of small size.

This pico projector notably comprises an input module for the video signal 17, an integrated logic module 18, a management module 8, an MEMS 24 (micromechanical systems) and a horizontal/vertical scanning control module 25.

In a variant, two or more MEMS can be used in place of the MEMS 24. Each of the MEMS is used for a given direction of the space.

This management module 8 is linked to three light sources 14, 15, 16, of different wavelength, included in this pico projector. The management module 8 is also connected to an active element 5 by link 26.

This management module 8 is suitable for driving each of the three light sources 14, 15, 16, as well as the active element 5. In the head-up display device, this active element 5 is arranged to receive a light beam from the projection means 4 and transmit it alternately to the display areas.

In the context of its operation, the laser pico projector is suitable for reconstructing an image point-by-point with a deflected laser beam. The deflection of the laser beam can be obtained with a microelectromechanical system MEMS such as, for example, a micro-mirror. The implementation of such MEMS technologies in pico projectors are described in the documents WO2012000556 and US2012013855.

The projection means 4, such as the pico projectors, comprise three laser light sources which are incorporated in an optical element in which each of the laser beams is aligned at the output using mirrors centered in wavelength, such as, for example, dichroic mirrors. Each laser, included in this projection means 4, is capable of addressing a spectral range in order to allow for a color rendition of the images:
800 nm to 620 nm for red,
560 nm to 492 for green, and
482 nm to 445 for blue.

Thus, different light sources of different wavelength are grouped together within a single projection means.

In this head-up display device, the screen 7 relates for example to a vehicle windshield 7 which is essentially transparent, notably with respect to light rays from the outside of the vehicle. This windshield or screen 7 comprises display areas for different types of rendition of a light beam. A near display area, substantially transparent, comprises electroluminescent particles 32 suitable for emitting a light radiation. A far display area is partially reflecting, notably with respect to a light beam from the interior of the vehicle. By having such areas that have different light beam rendition properties, comprising a reflection property, the screen 7 corresponds to a partially reflecting screen.

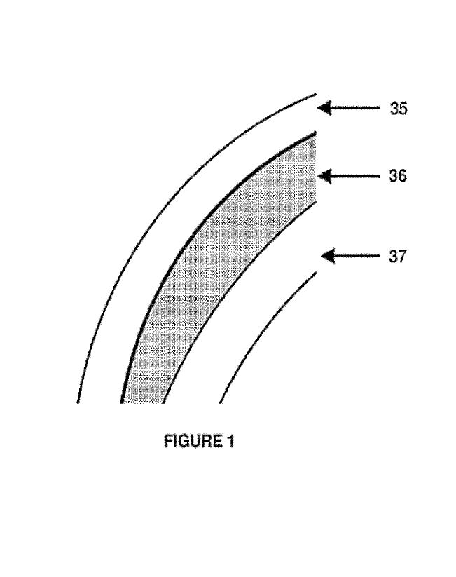

In effect, a near display area relates for example to a transparent area of the windshield 7 which comprises luminescent particles 32 suitable for emitting a radiation 33 of a wavelength in the visible range after absorption of the light beam 34. In effect, this area of the windshield is obtained by using luminescent particles 32 which are dissolved in the PVB (polyvinylbutyral) or included in a film bonded on surface of one of the glazed surfaces of the windshield 7. In the context of a laminated windshield 7, the latter is made up of two sheets of glass 35, 37 joined by a thermoplastic sheet of PVB 36, as is illustrated in FIG. 1.

The photoluminescent molecules are incorporated in the PVB layer 36 on the basis of inclusion mechanisms which are substantially similar to those described in the documents FR2914070B1, FR2929016A1, or even FR2929017A1.

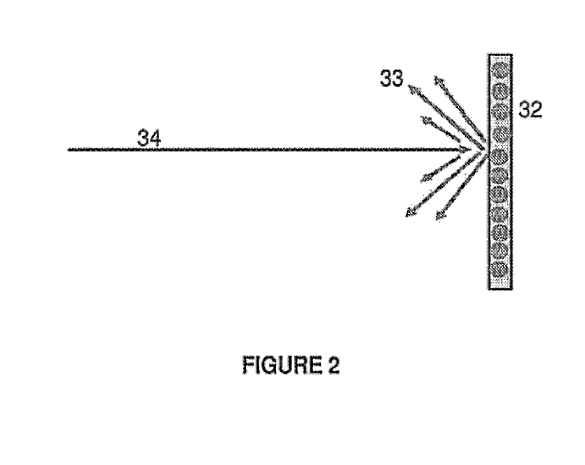

FIG. 2 illustrates these luminescent particles 32 which are excited by an incident radiation 34 of a certain wavelength and emitting a radiation 33 of another, longer wavelength which lies within the visible range, after absorption of the radiation of the first wavelength.

It will thus be noted that we have previously seen that, for a surface including luminescent particles, the exciting light must have a shorter wavelength than the light which will be re-emitted and visible. It is therefore potentially in the ultraviolet range and therefore invisible. In this case, the image is reconstructed in the plane of the photosensitive particles, that is to say, in the plane of the windshield 7.

Advantageously, the image displayed in such an area is visible to all the people whose field of vision covers the windshield 7. It will be noted that, to be visible to all these people, this area of the windshield 7 can also be produced by the addition of a reflecting surface or even by a relative position of the elements such that the image created by the system is in the field of vision of all these people through the windshield 7.

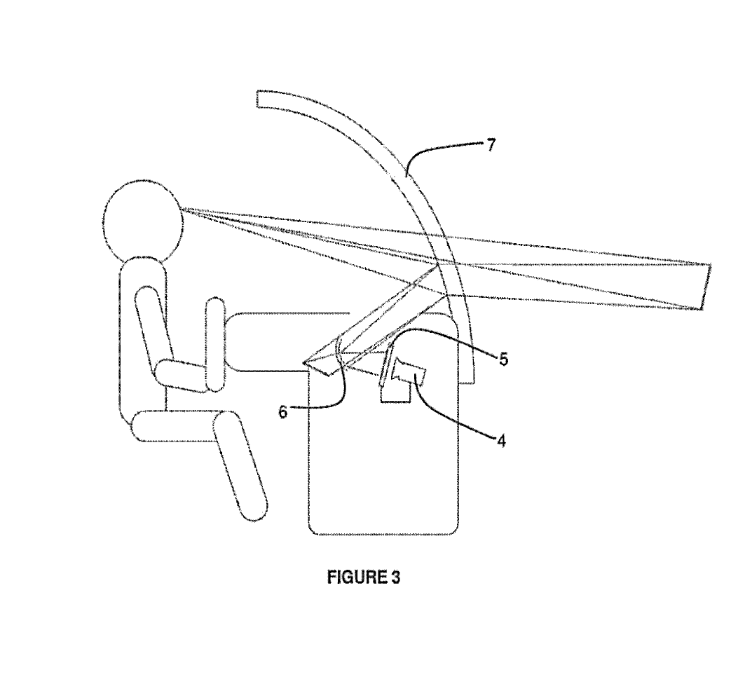

A far display area can relate, for example, to a partially reflecting area of the windshield 7. This display area is arranged so as to position a virtual image at a distance of at least 1 m from the partially reflecting screen 7, as is illustrated in FIG. 3. To do this, the projection means emits a visible light, and the image is then focused beyond this windshield 7. This image is generally visible only to the driver.

The characteristics of the light beam emitted by the projection means 4 vary as a function of the display area.

When the display area relates to the transparent area of the screen 7 comprising luminescent particles, the wavelength of the light beam, or exciting beam in this precise case, is lower than that of the light beam which will be emitted the screen, here the windshield. In other words, for an emission in the visible on the screen, that is to say the windshield, the wavelengths of the light beam (or exciting beam) are potentially in the ultraviolet range but also in the visible range in a short wavelength.

When the display area corresponds to the partially reflecting area, these wavelengths lie between 400 and 800 nm.

In one embodiment, the head-up display device comprises a number of projection means 4. Each projection means 4 is associated with a display area from an optical system defining an optical path between each projection means and this display area, to direct the light beam thereto.

A vehicle will comprise, in a non-exhaustive manner, two distinct projection means located differently in the vehicle, for two display areas.

A first projection means, such as any projection means 4 used generally in the conventional head-up display devices, will be used for the projection of an image in the far plane on an area of the partially reflecting windshield 7, and a second projection means such as a laser pico projector to address the luminescent particles of the display area of the windshield 7.

In another embodiment, contrary to the preceding embodiment, the head-up display device comprises only a single projection means to display an image on at least two display areas.

In this embodiment, the projection means for generating a light beam charged with an image to be displayed relates for example to a pico projector. This device also comprises an active element 5 arranged to receive the light beam from the projection means and transmit it over the optical path to the display areas. This active element 5 is linked to a light beam characteristics management module and is suitable for synchronizing the variation of the light transmission properties of said active element 5 as a function of said characteristics. This management module is included in the projection means and is suitable for driving the different light sources included in the projection means and the active element 5.

This active element 5 relates for example to an active diffuser of active light such as a PDLC (polymer dispersed liquid crystal) film. This PDLC film contains a mixture of liquid crystals and of polymers which have alignment properties that are variable as a function of the electrical polarization of said crystals.

This active element 5 is located downstream of the projection means. When an electrical polarization is generated by the management module, the PDLC film is then transparent. Conversely, if there is no electrical polarization, the film diffuses the light emitted by the projection means. Thus, the active element 5 can alternate between two states: transparent or diffusing.

When the projection means 4 is a laser pico projector, the source image then becomes that on the plane of the active diffuser when the latter is diffusing and the light rays pass through the active diffuser without being deflected when it is transparent.

Thus, by linking this active element 5 to a management module 18, it is then possible to discriminate two display areas with a single projection means 4.

In effect, the management module 18 makes it possible to synchronize the power source of the projection means with the source of electrical polarization of the active light diffuser.

For example, by synchronizing the source of electrical polarization of the active light diffuser and the power source of the projection means, here a source exciting luminophores of the area of the windshield 7 which includes the luminescent particles, a diffuse image is obtained on the active diffuser for the image focused in the far plane of the area of the partially reflecting windshield 7 and no image is obtained on the diffuser for the image in the plane of the windshield 7 which is formed directly in the area of the windshield 7 which includes luminescent particles.

This active element 5 can be of the transmissive or reflective type.

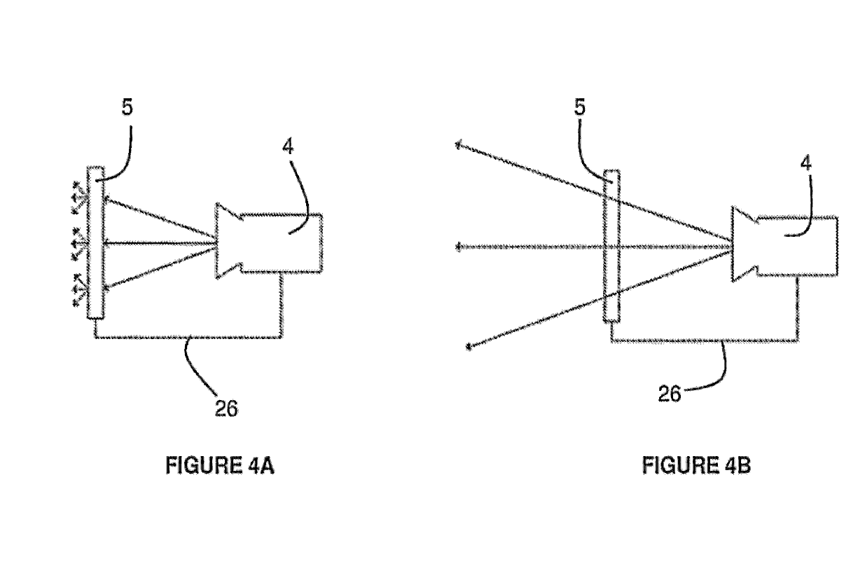

When the active element 5 is of the transmissive type, it is arranged between the projection means 4 and the display areas, as is represented in FIGS. 4A and 4B. Depending on the display area addressed, the active element 5 changes state by being either transparent or diffusing the light.

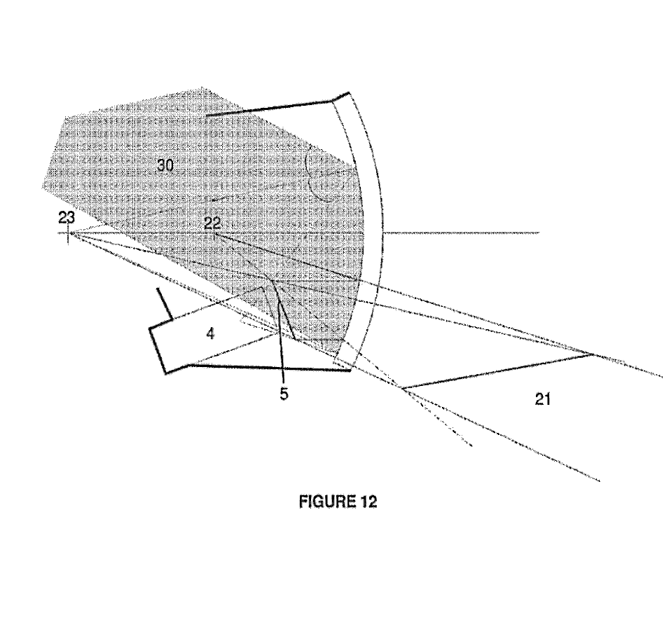

An example of a projection assembly of the device is represented in FIG. 12. This assembly comprises the projection means 4, a spherical mirror and an active element 5 of the transmissive type, which are arranged so as to generate the projection of a virtual image 21 and the reflection of an exciting source from a common source. The area 30 of the projection assembly is covered by the exciting scan after reflection by the spherical mirror. Points 23 and 22 correspond respectively to the center of the curvature of the spherical mirror and to the object focal point of this mirror.

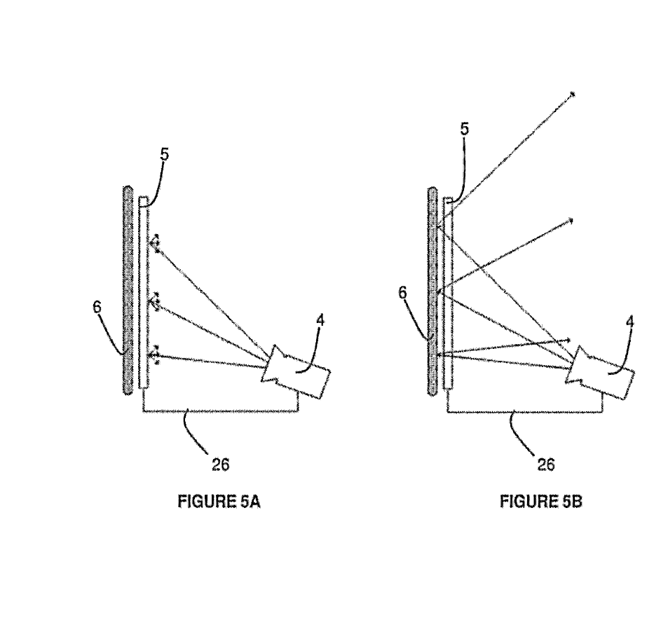

FIGS. 5A and 5B illustrate an active element 5 of the reflective type which is arranged between a mirror 6 and the projection means 4. In this configuration, the projection means 4 and the display areas are situated on the same side relative to the active element 5.

The mirror 6 thus makes it possible to reflect the light beam originating from the active element 5 on the optical path to the display areas.

It will be clearly understood that, when the active element 5 is in the diffusing state, it does not allow the light to pass. Thus, the light is always transmitted to the display area regardless of the state of the active element 5.

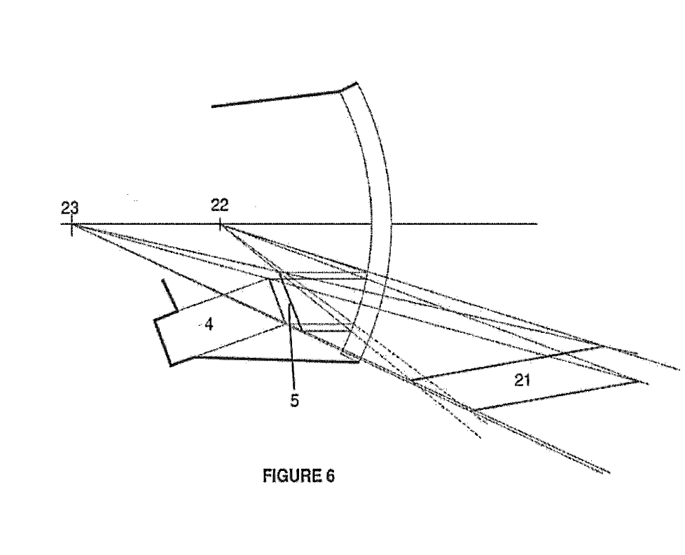

This head-up display device makes it possible, notably from the active element 5 of the transmissive or reflective type, to generate images in parallel focused in far planes of the display area of the partially reflecting windshield 7. In effect, in FIG. 6, the projection assembly of the device which is represented comprises the projection means 4, active elements 5 and a spherical mirror. This projection means 4, which is for example a color laser pico projector here, is suitable for creating images on the alternately transparent active elements 5. Thus, images are generated on a number of planes which will create sources of images at different positions which, after passage through an optic will create parallel virtual images 21 on different projection planes.

The invention relates also to a head-up display method, for displaying at least one image.

This method comprises the following steps:
generation by at least one projection means 4 of a light beam charged with an image to be displayed;
display in the field of vision of a user of said image in at least one predetermined display area arranged in a partially reflecting screen 7, and
definition by an optical system of an optical path between the projection means 4 and one of the display areas to direct the light beam onto the display area.

When the method is implemented by the head-up display device comprising a number of projection means, each being associated with a predefined display area, this method then comprises a step of synchronization of the projection means each cooperating with each display area of said screen 7, a synchronization step which is performed from the management module 18.

In the case where the head-up display device comprises only a single projection means 4, this display method comprises the steps of:
transmission of the light beam emitted by the projection means 4 to the display areas from the active element 5, and
synchronization of the variation of the light transmission properties of said active element 5 as a function of the characteristics of the light beam from the characteristics management module linked to said active element 5.

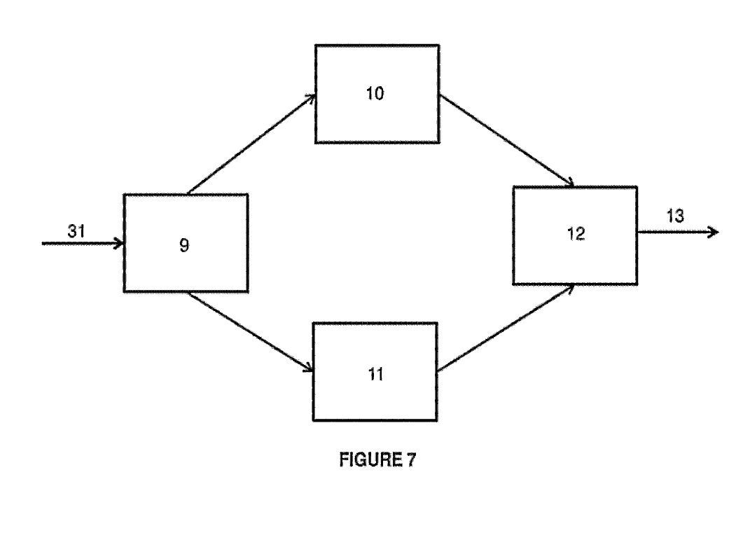

FIG. 7 shows a diagram relating to the interleaved image display mode in this head-up display device. This device receives a flow of information 31 to be displayed on each of the display areas. In a step of processing 9 of this information, the device performs a separation of the information according to each of the display areas. In generation steps 10 and 11, images intended for each of the display areas are created. In a step 12, these images are superposed in order for them to be addressed 13 on the display areas.

In the step of transmission of the light beam to one or other of the display areas, the variation of the light transmission properties of the active element 5 makes it possible to alternately address, in each display area, a pixel of an image to be displayed. This variation of the light transmission properties of said active element 5 is produced at a frequency higher than 24 Hz. Thus, interleaved images are then generated and addressed in these display areas.

The resolution of each of these images is lower than the maximum resolution of the display device. The sum of the pixels available in each of the axes for each of the images is equal to the total number of pixels on each of the axes. It will be noted that 100% of the addressable pixels are used.

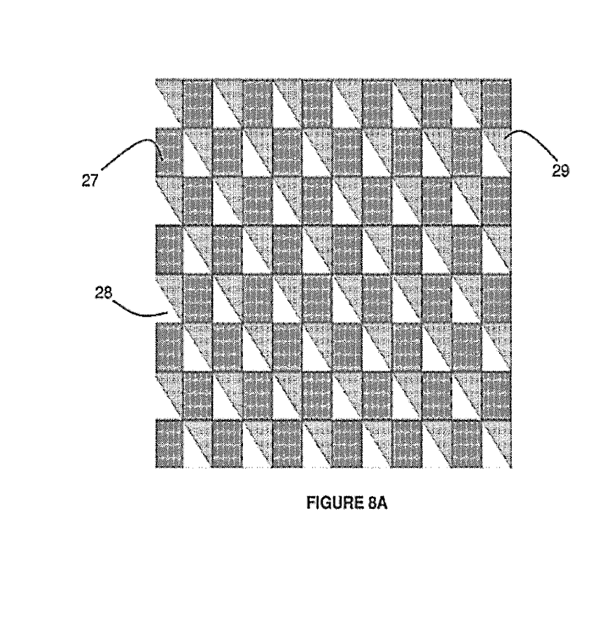

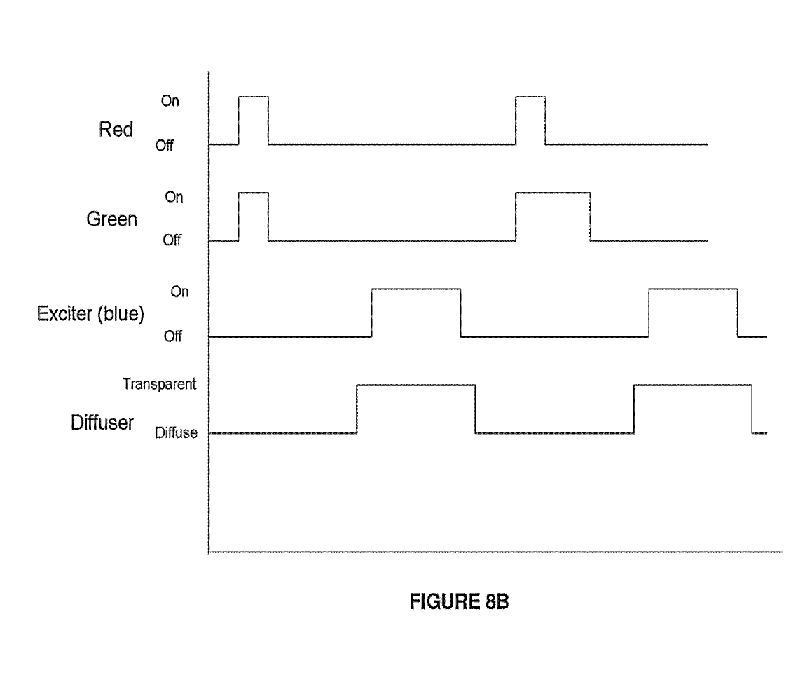

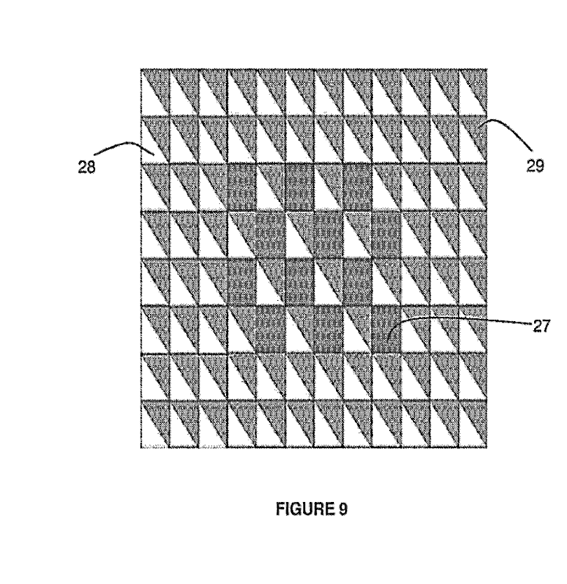

As is illustrated in FIG. 8B, the display of interleaved images is associated with a rapid driving of the active element 5 by the management module. With each change of display area, a change of state has to be applied to the active element 5: transparent or diffusing. This display of interleaved images produced from the driving of the Red, Green and Blue (exciting) light sources and the active element 5 (diffuser) which alternate between an on and off mode so as to alternately address a pixel for each display area.

In such a context, the driving frequency must be maximal and therefore greater than the product of the refresh rate of the images (higher than 24 Hz, retinal persistence) by the total number of pixels addressed by the system.

This image interleaving mode implemented by this device is illustrated in FIGS. 8A and 9, in which the blue pixels 27 represent the exciting source of the luminescent particles included in a display area of the windshield 7 and which are suitable for emitting a radiation of a wavelength in the visible range after absorption of the light beam. The green 28 and red 29 pixels being intended for the partially reflecting display area. In FIG. 9, unlike FIG. 8, the interleaved images are of different sizes and are displayed with a different number of pixels.

The advantage of the generation and the addressing on the interleaved image display areas is linked to the fact that this makes it possible to limit the display in regions of each of the display areas dynamically. Thus, the image display can be limited for a display area in the top right corner of the image for one series of information and in the bottom right corner for another application.

In this case, the excursion of the display means in each of the regions of these display areas and for each of the images will be maximal, which makes it possible to maximise the energy provided to each region as a function of the projection means 4.

The display mode with interleaved images will be used with active elements 5 allowing for a high-frequency driving and for displays in distinct display areas.

Alternatively, the images addressed to the display areas can be non-interleaved images or alternate images. The display mode of the images is then an alternate image addressing mode in the display areas.

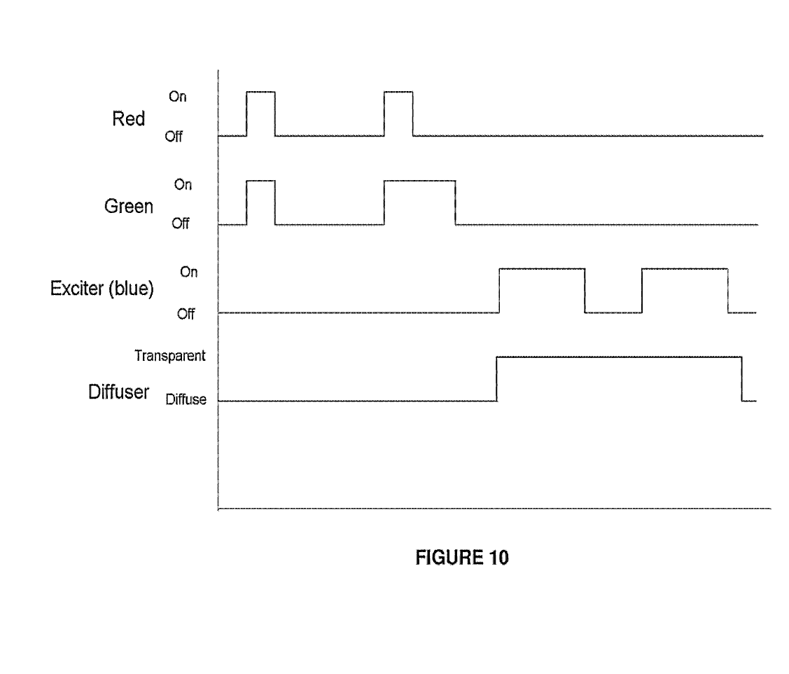

As is illustrated in FIG. 10, in this case, the transmission of the light beam to one or other of the display areas depends on the variation of the light transmission properties of said active element 5.

With each change of display area, a change of state has to be applied to the active element 5: transparent or diffusing. This display of non-interleaved images produced from the driving of the Red, Green and Blue (exciter) light sources, and the active element 5 (diffuser). In this context, the frequency of the projection means 4 is doubled as the red, green and blue light sources illustrate, with an alternate display of an image for each display area from the active element.

When the red and green light sources are on for the addressing of an image to the partially reflecting display area, then the active element 5 (the diffuser) is in “diffusing” mode and when the blue exciting light source (exciter) is on for the diffusion of an image to be addressed to the area of the windshield 7 including luminescent particles, the active element 5 (the diffuser) is in “transparent” mode.

This transmission is performed with:
a variation frequency higher than 24 Hz;
a frequency of generation of the light beam charged with an image to be displayed corresponding to twice the variation frequency.

Thus, by doubling the frequency of the projection means 4, an image is then displayed for each display area. For example, when an image is displayed for the far plane, that is to say in the partially reflecting area of the windshield 7, the active element 5 diffuses the image. And, when an image is displayed in the area of the windshield 7 including luminescent particles, the active element 5 is transparent.

In this context, the projection means 4 has to generate two times more images than if it had to display only a single image for a single display area in order to neutralize the retinal persistence. Similarly, the active element 5 is activated at an operating frequency at least equal to the retinal persistence, that is to say equal to half that of operation of the projection means 4. The management module 18 makes it possible to synchronize the projection means 4 with the active element 5 in such a way that the images, intended to be displayed in the area of the windshield 7 including luminescent particles, are displayed when the active element 5 is in the transparent state.

The advantage of the generation and the addressing on the display areas of non-interleaved images is that the active element 5 requires only driving at “low” frequencies, as can be seen in FIG. 10.

Furthermore, depending on the use of the assembly, it is possible to limit dynamically to regions of the display areas in each of the areas. Thus, the final luminescence of the assembly for each of the display areas is increased.

The display mode with non-interleaved images will be used with active elements 5 that do not allow for driving at high frequency, but with a projection means 4 that makes it possible to at least double the number of images displayed per second relative to the retinal persistence.

This head-up display device improves the display of information and driving comfort in vehicles. This device offers a display area that is sufficient for information linked to the navigation and multimedia information for example.

This device makes it possible to display information on near display areas, even in areas of the windshield 7.

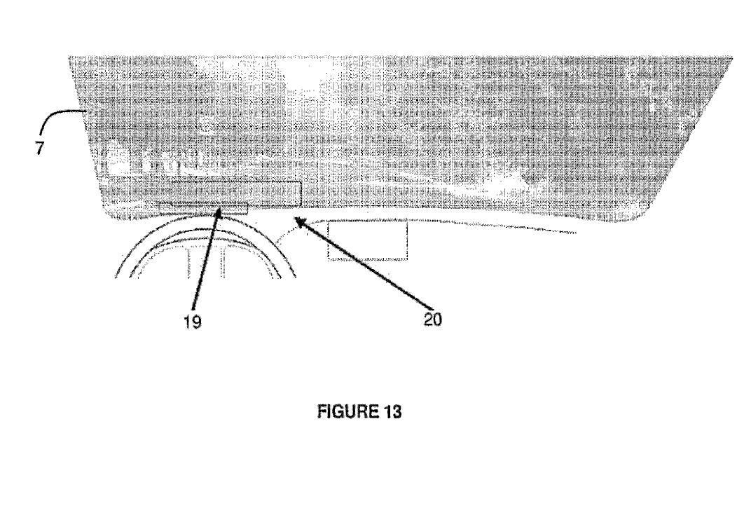

For example, the near display area may be appropriate for information relating to the driving: vehicle speed, regulator/limiter/ACC speed, speed limiting. As is illustrated in FIG. 13, this display area can be positioned in a so-called “medium” position 19, that is to say, in the field of vision of the driver in the bottom part of the windshield 7. This display area corresponds, non-exhaustively, to the area of the windscreen 7 which includes luminescent particles.

The partially reflecting area of the windshield 7, called far display area, can be used for the safety and alert information: ACC target, accident alert (“precrash”), distance alert (“distance warning”), trajectory drift alert (“lane departure warning”). As is represented in FIG. 13, this display area can be positioned in a so-called “up” position 20, that is to say in the field of vision of the driver above the near display area.

This area may also be appropriate for navigation applications which, projected in the environment, appear in “pseudo-augmented reality” mode.

A novel dimension emerges with these two display areas. In effect, it is possible to use elements in dynamic mode.

For example, with a classification of alerts in three risk levels—no risk; proven risk; proven danger. It is then possible to display a proven risk in the far display area and display it in the near display area when it becomes a proven danger. When there is no risk, there is no need to display the information so as not to distract the driver.

Thus, the incorporation of a number of display areas makes it possible to assist in organizing and prioritizing the information transmitted to the driver. Establishing new rules for the hierarchical organization of information will assist in the understanding of this information, as well as assisting the driver in his or her driving, will reduce his or her mental load by displaying only the information useful to the driving and the urgent alerts in the near plane.

The head-up display device according to the invention can be implemented with all types of transparent surfaces capable of displaying information such as, for example, window panes in commercial surfaces or electronic equipment with projected information.

1-9. (canceled)

10: A head-up display device, for displaying at least one image, comprising:
a projection means for generating a light beam charged with an image to be displayed;
a partially reflecting screen comprising at least one near display area and one far display area configured to display the image in a field of vision of a user; and
an active element to receive the light beam from the projection means and transmit the light beam alternately to the display areas.

11: The head-up display device as claimed in claim 10, wherein the active element is linked to a light beam characteristics management module which is configured to synchronize variation of light transmission properties of the active element as a function of the characteristics.

12: The head-up display device as claimed in claim 10, wherein the active element relates to an active light diffuser or a PDLC film.

13: The head-up display device as claimed in claim 10, wherein the near display area relates to an area of the partially reflecting screen comprising luminescent particles configured to emit a radiation of a wavelength in the visible range after absorption of the light beam.

14: The head-up display device as claimed in claim 10, wherein the projection means is a laser pico projector.

15: The head-up display device as claimed in claim 10, wherein the active element is of transmissive type and is arranged between the projection means and the display areas.

16: The head-up display device as claimed in claim 10, wherein the active element is of reflective type and is arranged between a mirror and the projection means, the mirror configured to reflect the light beam originating from the active element on an optical path toward the display areas.

17: A head-up display method, for displaying at least one image, comprising:
generating by at least one projection means a light beam charged with an image to be displayed;
displaying in a field of vision of a user the image in at least one near display area and one far display area arranged in a partially reflecting screen; and
alternate transmission by an active element of the light beam emitted by the projection means to the display areas.

18: The head-up display method as claimed in claim 17, further comprising:
synchronizing a variation of light transmission properties of the active element as a function of characteristics of the light beam from a management module for the characteristics linked to the active element.
